(19) United States
(12) Patent Application Publication
(10) Pub. No.: US 2015/0233324 A1
(43) Pub. Date: Aug. 20, 2015

(54) TWO-MODE IGNITOR AND A TWO-MODE METHOD OF INJECTION FOR IGNITING A ROCKET ENGINE

(71) Applicant: SNECMA, Paris (FR)

(72) Inventors: Jean-Luc Le Cras, Saint-Marcel (FR); Cyril Verplancke, Asnieres-Sur-Seine (FR)

(73) Assignee: SNECMA, Paris (FR)

(21) Appl. No.: 14/422,790

(22) PCT Filed: Aug. 13, 2013
(86) PCT No.: PCT/FR2013/051932

§ 371 Date: Feb. 20, 2015

(30) Foreign Application Priority Data
Aug. 20, 2012 (FR) 1257878

(51) Int. Cl. F02K 9/95; F02K 9/60; F02K 9/44

(52) U.S. Cl. CPC F02K 9/95; F02K 9/44; F02K 9/605; F05D 2220/80; F05D 2260/99

(57) ABSTRACT

A two-mode ignitor and to a two-mode method of injection into the ignitor, which includes a feed for a first propellant, a feed for a second propellant, a feed for a high pressure fluid, a first buffer tank, a second buffer tank, a first switch device, a second switch device, and a torch-forming combustion chamber; a downstream orifice from the first buffer tank and a downstream orifice from the second buffer tank both open out into the combustion chamber; the first switch device and second switch device devices are configured respectively to connect an upstream orifice of the first buffer tank with either the first feed or with the feed for high pressure fluid, and to connect the upstream orifice of the second buffer tank either with the second feed or with the feed for the high pressure fluid.

### FIELD OF THE INVENTION

The present description relates to a two-mode ignitor and to a two-mode method of injection for the ignitor suitable for starting a rocket engine both under low pressure conditions and under high pressure conditions.

Such an ignitor or method may be used to enable a rocket engine to be started or restarted under various operating and pressure conditions, on the ground or in flight, at low altitude, or at high altitude.

### STATE OF THE PRIOR ART

Rocket engines operate by causing two propellants to meet and combust within a combustion chamber, the propellants generally being oxygen and hydrogen. It is the burnt gas generated by the combustion and escaping at very high speed from the combustion chamber, generally via a diverging nozzle, that acts by reaction to produce the thrust for propelling the rocket.

Once such combustion has started, it is self-sustaining so long as the propellants continue to be fed. Nevertheless, when such an engine uses large volumes of propellant, starting it also requires a large quantity of energy in order to initiate combustion, and in particular more energy than a spark plug is capable of delivering. Thus, rocket engines are fitted with ignitors that enable the combustion reaction to be initiated in the combustion chamber of the engine.

Such ignitors include torch ignitors that, unlike pyrotechnic ignitors, are reusable and therefore make it possible to restart the engine in flight, should that be necessary. Such a torch ignitor consists in a small combustion chamber that is fed with propellants and that has a spark plug that is capable of igniting the small quantity of propellants fed thereto: the flames as generated in this way are then channeled in the form of a torch to the combustion chamber of the engine, and they have sufficient energy to initiate combustion therein and start the engine.

Nevertheless, at present, only two types of torch ignitors are known, each of which has only one operating point. There are firstly low pressure ignitors that are fed with propellants pressurized at the low pressure of the tanks: unfortunately, such ignitors are inoperative whenever there is back pressure present in the combustion chamber, i.e. in particular on the ground or at low altitude. They also deliver rather little energy and might potentially fail to start the engine or require several attempts before the engine actually starts. There also exist high pressure ignitors in which the propellants are stored in tanks that are pressurized to high pressure. Nevertheless, such tanks are heavy and therefore very expensive.

There therefore exists a real need for a two-mode ignitor and for a two-mode method of injection in order to perform ignition for the purpose of starting a rocket engine both under low pressure conditions and under high pressure conditions, while avoiding the drawbacks inherent of the above-mentioned prior art ignitors.

### SUMMARY OF THE INVENTION

The present description relates to a two-mode ignitor for a rocket engine suitable for operating at low pressure or at high pressure, it comprises a feed for feeding a first propellant; a feed for feeding a second propellant, a feed for feeding a high pressure fluid, a first buffer tank, a second buffer tank, a first switch device, a second switch device, and a torch-forming combustion chamber; a downstream orifice from the first buffer tank and a downstream orifice from the second buffer tank both open out into the combustion chamber, and the first switch device and the second switch device are configured respectively to connect an upstream orifice of the first buffer tank with either the feed for feeding a first propellant or with the feed for feeding a high pressure fluid, and to connect the upstream orifice of the second buffer tank either with the feed for feeding a second propellant or with the feed for feeding the high pressure fluid.

In the present description, the terms “upstream” and “downstream” are used relative to the flow of the fluids, whether propellants or high pressure fluid, from their tanks to the combustion chamber.

Thus, in low pressure operation, the propellants flow from their feed tanks in which they are stored at low pressure, they pass through their respective buffer tanks, and they penetrate into the combustion chamber of the ignitor where they mix together; the mixture of propellants is then ignited, thereby creating a torch suitable for initiating the combustion of the propellant in the main combustion chamber of the rocket engine. This low pressure operation is particularly adapted to ignition or re-ignition while flying at high altitude such that the back pressure that exists in the combustion chamber of the rocket engine and thus in the combustion chamber of the ignitor is low or a vacuum.

Conversely, on the ground, at takeoff or on a test bench, or when the chamber has just ignited, back pressure is present in the combustion chamber of the engine and thus in the combustion chamber of the ignitor: this back pressure then acts against the low pressure propellants and can prevent them being injected in part or at all into the combustion chamber of the ignitor, thus making ignition uncertain. In particular, the back pressure becomes effective and large once the combustion chamber of the engine has ignited, thereby disturbing the low pressure operation of the ignitor, which then becomes less effective for maintaining combustion in the chamber during the critical transient and unstable stage of combustion that lasts for a short period after ignition. Under such circumstances, when operating at high pressure, a high pressure fluid is used that is injected into the buffer tank after the propellant has previously been placed therein in order to pressurize the propellant and thrust it into the combustion chamber of the ignitor, in spite of the force exerted by the back pressure that exists in the combustion chamber. Ignition of the engine is thus also ensured under these conditions that require high pressure operation.

Thus, by means of the architecture of the present invention, it is possible to obtain an ignitor that has two operating points, a low pressure operating point and a high pressure operating point, and that is thus capable of using a single, compact architecture, to adapt to the various conditions that are to be encountered by a rocket engine during its mission. In particular, this architecture makes it possible, for both modes of operation, to use the same low pressure propellant feeds, that may indeed also correspond to the sources for feeding the rocket engine itself. Furthermore, in order to make high pressure operation possible, it thus becomes pointless to include distinct pressurized propellant tanks, which are particularly heavy and bulky.

In certain embodiments, the high pressure fluid is a purge fluid for the ignitor. In a conventional rocket engine, a pressurized tank of purge fluid is often provided in order to enable certain pipes to be purged and in particular, for an ignitor, pipes for feeding propellants. In such an embodiment, it is then possible to take advantage of the existence of such a high pressure purge fluid tank in order to have a high pressure fluid feed suitable for the present invention without requiring a new on-board pressurized tank: the weight of the engine is thus substantially unchanged, thereby greatly limiting its cost. Furthermore, by the very principle whereby this embodiment injects the purge fluid directly after the propellants, purging takes place immediately without any latency time, thereby reducing any risk of the ignitor overheating when stopped.

In certain embodiments, the high pressure fluid is not reactive. Its injection is therefore neutral from the point of view of the ignitor. In particular, there is no risk of it reacting with one of the propellants and thus interfering with the combustion reaction between the propellants or indeed damaging the ignitor. It may also be selected to avoid reacting with the materials of the ignitor, in particular by corrosion, oxidation, or reduction. This high pressure fluid is thus preferably dinitrogen N2 or helium He.

In certain embodiments, the first buffer tank is a feed pipe for feeding the first propellant to the combustion chamber. Combining the functions of conveying the propellants and of providing buffer storage of the propellants enables the architecture to be compact and light in weight.

In certain embodiments, the second buffer tank is a feed pipe for feeding the second propellant to the combustion chamber.

In certain embodiments, the respective volumes of the buffer tanks are configured so that during high pressure operation, a desired mixing ratio is maintained for a duration that is sufficient to enable ignition. The volumes of the buffer tanks determine the respective quantities of propellants that are injected during ignition and thus they determine the mixing ratio. By acting on the volumes of the respective buffer tanks, and in particular by acting on the length and/or the section of a tank constituted by a pipe, it is thus possible to adjust the mixing ratio and thus the operating point of the ignitor, where such adjustment is not possible in a conventional low pressure ignitor that injects each of the propellants at a respective fixed calibrated flow rate.

In certain embodiments, the desired mixing ratio lies in the range 1.5 to 3.5, and preferably in the range 2 to 3, and more preferably is approximately equal to 2.5.

In certain embodiments, the desired mixing ratio is maintained for at least 0.3 seconds (s), and preferably for at least 0.5 s, and more preferably for at least 1 s.

In certain embodiments, the first feed pipe has a volume lying in the range 0.5 liters (L) to 2.5 L, preferably lying in the range 0.8 L to 2 L, and more preferably equal to about 1.6 L.

In certain embodiments, the second feed pipe possesses a volume lying in the range 0.08 L to 0.39 L, preferably in the range 0.13 L to 0.31 L, and more preferably is equal to 0.26 L. In certain embodiments, the first switch device comprises a check valve arranged at the outlet from the first propellant feed in order to interrupt feeding propellant while feeding high pressure fluid. The check valve acts automatically and instantaneously to interrupt the feed of first propellant when the high pressure fluid is released, given that its pressure is naturally much greater than the pressure of the propellant. Furthermore, no high pressure fluid is delivered to the propellant feed.

In certain embodiments, the second switch device includes a check valve arranged at the outlet from the feed for feeding the second propellant in order to interrupt the feed of propellant when feeding high pressure fluid.

In certain embodiments, the first switch device includes a solenoid valve controlling the feed of high pressure fluid to the first buffer tank.

In certain embodiments, the second switch device includes a solenoid valve controlling the feed of high pressure fluid to the second buffer tank.

In certain embodiments, the first switch device includes a second check valve arranged at the outlet from the high pressure fluid feed in order to prevent the first propellant from flowing into the high pressure fluid feed.

In certain embodiments, the second switch device includes a second check valve arranged at the outlet from the high pressure fluid feed in order to prevent the second propellant from flowing into the high pressure fluid feed.

In certain embodiments, the high pressure fluid feed includes a first expander configured to control the pressure of the high pressure fluid while it is being fed to the first buffer tank. In this way, it is possible to adjust the pressure at which the propellant present in the buffer tank is injected during injection of the high pressure fluid, and thus to control the flow rate at which the propellant is injected and the operating point of the ignitor.

In certain embodiments, the high pressure fluid feed includes a second expander configured to adjust the pressure of the high pressure fluid when it is fed to the second buffer tank.

In certain embodiments, the first and second propellant feeds are low pressure feeds, in particular feeds at a pressure lower than 4 bar.

In certain embodiments, the first and second propellant feeds are the propellant tanks of the rocket engine itself. It is thus possible to share these feeds and thus to improve compactness and reduce weight.

In certain embodiments, the first propellant is gaseous dihydrogen (GH2) and the second propellant is gaseous dioxygen (GOx).

In certain embodiments, the high pressure fluid is delivered at a pressure higher than 10 bar, preferably higher than 20 bar. In this way, it is possible to decouple the operation of the ignitor from the pressure that exists in the chamber, even once the chamber has ignited at the beginning of a transient stage in which pressure increases.

The present description also provides a method of injecting a propellant into a combustion chamber forming a torch of a rocket engine ignitor in two modes, a low pressure mode or a high pressure mode. The method comprises the following steps: in low pressure mode, feeding the combustion chamber of the ignitor with propellant taken from a low pressure tank; and in high pressure mode, previously storing the propellant in a buffer tank and then injecting high pressure fluid after the previously stored propellant in order to pressurize the propellant and expel it at high pressure to the combustion chamber.

Amongst other advantages, this obtains the advantages of the above-described two-mode ignitor.

In certain implementations, the high pressure fluid is a purge fluid for the ignitor, preferably a non-reactive fluid such as dinitrogen or helium.

In certain implementations, use is made of the volume formed by a feed pipe for feeding the propellant to the combustion chamber in order to constitute the buffer tank.

In certain implementations, the dimensioning of said feed pipe is designed to maintain a desired flow rate of propellant for a duration that is sufficient to enable ignition.

Finally, the present description also relates to a rocket engine including an ignitor as described above and/or performing the above-described method.

The above-mentioned characteristics and advantages, and others, appear on reading the following detailed description of embodiments of the proposed ignitor and method. This detailed description is made with reference to the accompanying drawings.

### BRIEF DESCRIPTION OF THE DRAWINGS

The accompanying drawings are diagrammatic and seek above all to show the principles of the invention.

In these figures, from one figure to another, elements (or portions of an element) that are identical are identified by the same reference signs.

FIG. 1 is a diagrammatic elevation view of an embodiment of an ignitor of the invention when operating at low pressure.

FIG. 2 is a diagrammatic elevation view of the FIG. 1 ignitor when operating at high pressure.

### DETAILED DESCRIPTION OF EMBODIMENT(S)

In order to make the invention more concrete, an example ignitor 1 is described in detail below with reference to the accompanying drawings. It should be recalled that the invention is not limited to this example.

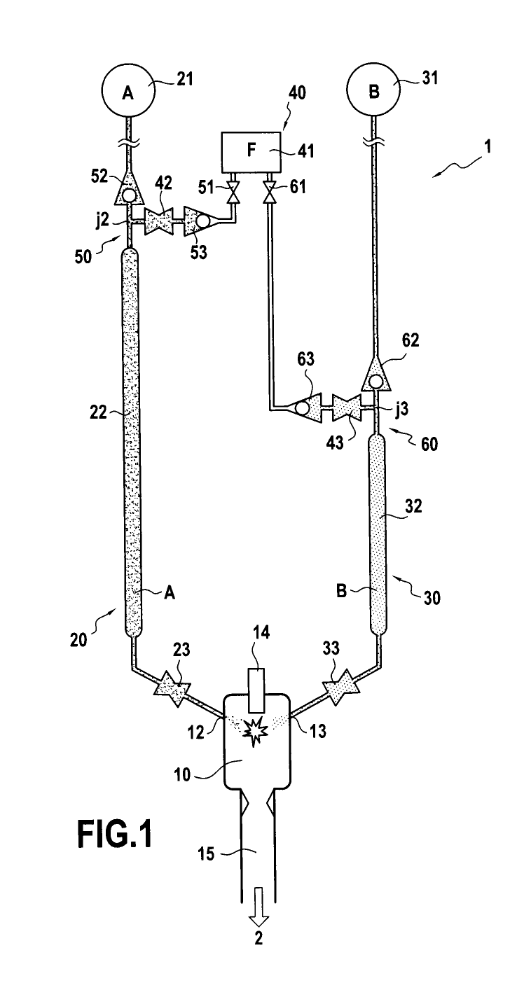

FIG. 1 shows an embodiment of an ignitor 1 of the invention. It is made up of a combustion chamber 10, a first feed line 20 for feeding a first propellant A, in this example gaseous hydrogen GH2, and a second feed line 30 for feeding a second propellant B, in this example gaseous oxygen GOx, together with purge equipment 40.

The combustion chamber 10 has a first propellant inlet 12 to which the feed line 20 for feeding the first propellant A leads, a second propellant 13 to which the feed line 30 for feeding the second propellant B leads, a spark plug 14 arranged within the combustion chamber 10 so as to be substantially at the confluence between the streams of propellants A and B penetrating into the chamber 10 via the inlets 12 and 13, and a channel 15 extending from this confluence zone towards the combustion chamber 2 of the rocket engine.

The feed line 20 for feeding the first propellant A includes a feed tank 21 for feeding the first propellant A, a feed pipe 22 forming a buffer tank, and a calibrator device 23 operating in this example as a sonic throat, that is arranged at the downstream end of the feed line 20 before it leads into the combustion chamber 10 via the inlet 12.

Likewise, the feed line 20 for feeding the second propellant B comprises a feed tank 31 for the first propellant B, a feed pipe 32 forming a buffer tank, and a calibrator device 33 likewise operating as a sonic throat, arranged at the downstream end of the feed line 30 before it leads into the combustion chamber 10 via the inlet 13.

In this embodiment, the feed tanks 21 and 31 are also the tanks that feed propellant to the main combustion chamber 2 of the rocket engine itself. The gaseous hydrogen A and the gaseous oxygen B are available therein at a pressure of about 3 bar.

The purge equipment 40 comprises a pressurized tank 41 of a high pressure purge fluid F, in this example gaseous dinitrogen N2 (it could equally well be helium). This equipment is connected to the feed line 20 for feeding the first propellant A at a junction point j2 that is situated upstream from the feed pipe 22 forming a buffer tank, via a first switch device 50. It is also connected to the feed line 30 for feeding the second propellant B via a junction point j3 that is situated upstream from the feed pipe 22 that forms a buffer tank, via a second switch device 60. In addition, the purge equipment 40 includes a first calibrator device 42 and a second calibrator device 43 that are arranged respectively before the junction point j2 with the first feed line 20 and before the junction point j3 with the second feed line 30.

In this embodiment, the high pressure fluid tank 41 is the common nitrogen tank of the rocket. It feeds high pressure fluid at a pressure of about 300 bar, which pressure may be reduced for the requirements of the present ignitor 1 to a pressure of about 25 bar.

Thus, in this embodiment, the high pressure fluid tank 41 is common to both feed lines 20 and 30; nevertheless, in other embodiments, the purge equipment could comprise a first high pressure fluid tank for the first feed line 20 and a second high pressure fluid tank for the second feed line 30.

The first switch device 50 comprises a gate valve 51, a first check valve 52, and a second check valve 53. The gate valve 51, in this example a valve of the solenoid valve type, is arranged between the pressurized tank 41 of high pressure fluid and the junction point j2: it serves to control the feed of high pressure fluid F. The first check valve 52 is arranged between the junction point j2 and the first propellant feed tank 21: it is directed so as to close when the high pressure fluid F is flowing in the first feed line 20. Under such circumstances, the feed of first propellant A is interrupted and the high pressure fluid F is prevented from flowing back into the feed tank 21. The second check valve 52 is arranged between the junction point j2 and the gate valve 51: it is directed in such a manner as to close when the high pressure fluid F is not flowing in the first feed line 20, in particular when the gate valve 51 is closed. Under such circumstances, the first propellant A is prevented from flowing back beyond the check valve 53.

The second switch device 60 comprises a gate valve 61, a first check valve 62, and a second check valve 63. Their positions and functions are entirely analogous for the second feed line 30 to the positions and functions of the first switch device 50.

In a variant embodiment, the purge equipment 40 may be provided with a single gate valve controlling the feed of high pressure fluid F to both feed lines 20 and 30, with the bifurcation to these two lines 20 and 30 being provided downstream from said gate valve.

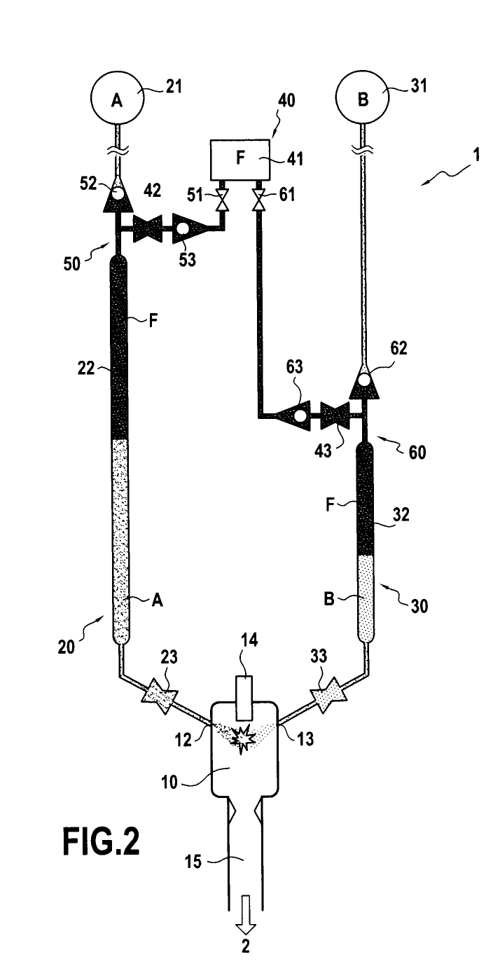

The operation of the ignitor 1 is described below with reference to FIGS. 1 and 2, which show respectively low pressure and high pressure conditions.

When the pressure in the combustion chamber 2 of the rocket engine, and thus in the combustion chamber 10 of the ignitor 1, is negligible or at least smaller than the pressure of the propellants A and B contained in tanks 21 and 31, which pressure is about 3 bar in this example, the ignitor 1 is used in low pressure mode, as shown in FIG. 1.

In this low pressure mode, the gate valves 51 and 61 for the purge fluid F are closed and the feed lines 20 and 30 are fed with the propellants A and B contained in the feed tanks 21 and 31: the propellants A and B thus pass respectively through the check valves 52 and 62, pushing back and closing the check valves 53 and 63, and they flow along their respective feed pipes 22 and 32 so as to pass through the expanders 23 and 33 and be injected into the combustion chamber 10 via the inlets 12 and 13. The spark plug 14 then delivers an electric spark that ignites the mixture of propellants A and B present in the combustion chamber 10 of the ignitor 1: the flames produced in this way are then directed by the channel 15 from the chamber 10 to the combustion chamber 2 of the rocket engine in order to ignite the combustion reaction therein.

In contrast, when the pressure in the combustion chamber 2 of the rocket engine, and thus in the combustion chamber 10 of the ignitor 1, is high enough to exert sufficient back pressure to oppose conventional injection of the propellants A and B into the combustion chamber 10, then the ignitor 1 is used in high pressure mode, as shown in FIG. 2.

In this high pressure mode, the feed pipes 22 and 32 forming buffer tanks are initially filled with their respective propellants A and B from the feed tanks 21 and 31. This filling is performed at low pressure in the manner described above.

Once these buffer volumes of the propellants A and B are stored in their respective feed pipes 22 and 32 forming buffer tanks, the valves 51 and 61 are opened: in each line 20, 30 of the ignitor 1, the high pressure fluid F is then delivered via the check valves 53, 63 and the expander 42, 43, pushing back and closing the check valves 52 and 62, thereby preventing the propellants A or B being fed and preventing the high pressure fluid F being delivered towards the feed tanks 21, 31. The high pressure fluid F then penetrates into the feed pipes 22, 32 where it exerts pressure like a piston against the previously stored buffer volumes of the propellants A, B, thereby pressurizing it and thrusting it towards the combustion chamber 10 via the expander 23, 33 and the inlet 12, 13.

In such a high pressure mode, the quantities of propellants A and B that are injected, and thus their mixing ratio, can be determined easily when designing the ignitor 1 by adjusting the volume of each of the feed pipes 22, 32 that forms a buffer tank and also by appropriately designing the calibrator devices 42 and 23 for the propellant A and 43 and 23 for the propellant B in order to determine the flow rates of the propellants A and B and of the high pressure fluid FB. In this embodiment, the feed pipe 22 for feeding hydrogen A thus possesses a volume of about 1.6 L while the feed pipe 32 for feeding oxygen B possesses a volume of about 0.26 L: these volumes thus enable a mixing ratio of about 2.5 to be maintained for about 1 s, which is a duration that is long enough to enable ignition to take place.

On being injected in this way at high pressure, the propellants A and B mix within the combustion chamber 10 and are ignited with the help of a spark produced by the spark plug 14. In this mode likewise, it is the flames that are produced in this way and that are directed towards the combustion chamber 2 of the rocket engine via the channel 15 of the ignitor 1 that serves to ignite the combustion reaction in the rocket engine.

The embodiments or implementations described in the present description are given by way of non-limiting illustration and, in the light of this description, a person skilled in the art can easily modify these embodiments or implementations, or can envisage others, while remaining within the ambit of the invention.

Furthermore, the various characteristics of these implementations or embodiments can be used on their own or can be combined with one another. When they are combined, the characteristics may be combined as described above or in other ways, the invention not being limited to the specific combinations described in the present description. In particular, unless specified to the contrary, a characteristic described with reference to any one embodiment or implementation may be applied in analogous manner to any other embodiment or implementation.

1. A two-mode ignitor for a rocket engine suitable for operating at low pressure or at high pressure, the ignitor comprising:
a low pressure feed for feeding a first propellant;
a low pressure feed for feeding a second propellant;
a feed for feeding a high pressure fluid;
a first buffer tank;
a second buffer tank;
a first switch device;
a second switch device; and
a torch-forming combustion chamber;
wherein a downstream orifice from the first buffer tank and a downstream orifice from the second buffer tank both open out into the combustion chamber;
wherein the first switch device and the second switch device are configured respectively to connect an upstream orifice of the first buffer tank with either the feed for feeding the first propellant or with the feed for feeding high pressure fluid, and to connect the upstream orifice of the second buffer tank either with the feed for feeding the second propellant or with the feed for feeding the high pressure fluid; and
wherein the respective volumes of the first buffer tank and of the second buffer tank are configured so that during high pressure operation the desired flow rates of the first propellant and of the second propellant are maintained for a duration that is sufficient to enable ignition.

2. A two-mode ignitor according to claim 1, wherein the high pressure fluid is a purge fluid for the ignitor, preferably a non-reactive fluid such as dinitrogen or helium.

3. A two-mode ignitor according to claim 1, wherein the first buffer tank is a feed pipe for feeding the first propellant to the combustion chamber, and the second buffer tank is a feed pipe for feeding the second propellant to the combustion chamber, the respective volumes of the buffer tanks being configured so that during operation at high pressure, a desired mixing ratio is maintained for a duration that is sufficient to enable ignition.

4. A two-mode ignitor according to claim 1, wherein the first switch device includes a check valve arranged at the outlet from the feed for feeding the first propellant in order to interrupt the feed of first propellant when feeding high pressure fluid.

5. A two-mode ignitor according to claim 1, wherein the first and second propellants are delivered at pressures of lower than 4 bar.

6. A two-mode ignitor according to claim 5, wherein the feeds for feeding the first and second propellants are the propellant tanks of the rocket engine itself.

7. A two-mode ignitor according to claim 1, wherein the high pressure fluid is delivered at a pressure higher than 10 bar, preferably higher than 20 bar.

8. A method of injecting a propellant into a combustion chamber forming a torch of a rocket engine ignitor in two modes, a low pressure mode or a high pressure mode, the method comprising the following steps:
in low pressure mode, feeding the combustion chamber of the ignitor with propellant taken from a low pressure tank; and
in high pressure mode, previously storing the propellant in a buffer tank and then injecting high pressure fluid after the previously stored propellant in order to pressurize the propellant and expel it at high pressure to the combustion chamber.

9. A method according to claim 8, wherein the high pressure fluid is a purge fluid for the ignitor, including dinitrogen or helium.

10. A method according to claim 8, wherein use is made of the volume formed by a feed pipe for feeding the propellant to the combustion chamber in order to constitute the buffer tank, the dimensioning of the buffer tank being designed to maintain a desired flow rate of propellant for a duration that is sufficient to enable ignition.

11. A rocket engine, comprising an ignitor according to claim 1.
